(19) United States
(12) Patent Application Publication
(10) Pub. No.: US 2018/0273132 A1
(43) Pub. Date: Sep. 27, 2018

(54) BICYCLE FRONT FORK AND INTERNAL CABLE ROUTING SYSTEM

(71) Applicant: Wei Hau Accessories Co., Ltd., Yongjin Township (TW)

(72) Inventor: Yuan-Hsin HUANG, Yongjing Township (TW)

(73) Assignee: Wei Hau Accessories Co., Ltd.

(21) Appl. No.: 15/597,307

(22) Filed: May 17, 2017

(30) Foreign Application Priority Data
Mar. 22, 2017 (TW) 106204024

(51) Int. Cl. B62K 21/02; B62K 21/18; B62K 21/12; B62K 19/32; B62K 19/06; B62K 19/38; B62K 23/06

(52) U.S. Cl. CPC B62K 21/02; B62K 21/18; B62K 21/12; B62K 3/04; B62K 19/06; B62K 19/38; B62K 23/06; B62K 19/32

(57) ABSTRACT

A front fork for a bicycle is disclosed. The bicycle includes a handlebar, a stem, a headset, a frame and the front fork. The frame has a top tube, a down tube and a hollow head tube, and the stem secures the handlebar to the front fork via the headset such that movement of the handlebar results in movement of the stem and the front fork. The front fork comprises a pair of hollow tubular fork legs and a hollow steerer tube connected to the pair of hollow tubular fork legs and has a first opening formed thereon. Wherein the hollow head tube has a second opening formed thereon and corresponding and communicating to the first opening of the hollow steerer tube when the hollow steerer tube of the front fork is secured to the stem through the hollow head tube.

### FIELD OF THE INVENTION

The present invention relates to a bicycle and a front fork thereof, and more particularly, to a bicycle having internally routed brake and shift cables and a front fork thereof.

### BACKGROUND OF THE INVENTION

Bicycles commonly have flexible cables used for remotely actuating various bicycle components. For example, cables can be used to link brake levers attached on the handlebars to brake calipers at remote locations in order to facilitate actuation of the brakes by squeezing the brake levers. Cables can also be used for remote actuation of other components, such as shifters.

Referring to FIG. 1, which is a schematic diagram of a conventional bicycle. As shown in FIG. 1, the bicycle has two brake levers and a shift lever attached to respectively two ends of the handlebar. Brake cables 3 and shift cables 2 are routed through cable housing 4 that facilitate the routing of the brake and shift cables along curved path. The cables 2,3 and the cable housing 4 are commonly routed along the exterior of a frame 1 and a front fork 5, and thus are visible and can reduce the aerodynamic efficiency of the bicycle.

The conventional bicycle has the following problems: It is difficult to clean up the dirt because of the cables will be easier dirt and moist. In addition, due to the exposure of the cable assembly, it is easy to be scratched to cause the metal wire inside the cables to rust, and thus affecting the safety of cycling.

### SUMMARY OF THE INVENTION

Therefore, it is an object of the claimed invention to provide a significantly improved bicycle having internally routed brake and shift cables and a front fork thereof.

In accordance with an exemplary embodiment of the claimed invention, a front fork for a bicycle is provided. The bicycle includes a handlebar, a stem, a headset, a frame and the front fork. The frame has a top tube, a down tube and a hollow head tube, and the stem secures the handlebar to the front fork via the headset such that movement of the handlebar results in movement of the stem and the front fork. The front fork comprises a pair of hollow tubular fork legs and a hollow steerer tube connected to the pair of hollow tubular fork legs and has a first opening formed thereon. Wherein the hollow head tube has a second opening formed thereon and corresponding and communicating to the first opening of the hollow steerer tube when the hollow steerer tube of the front fork is secured to the stem through the hollow head tube.

In accordance with an exemplary embodiment of the claimed invention, the shape of the first opening of the hollow steerer tube is selected from one of an oval, an oblong and a circle.

In accordance with an exemplary embodiment of the claimed invention, the second opening of the hollow head tube communicates with the down tube of the frame.

In accordance with an exemplary embodiment of the claimed invention, the hollow head tube further comprises a third opening communicating with the top tube of the frame, the first opening of the hollow steerer tube respectively communicates with the second opening and the third opening.

In accordance with an exemplary embodiment of the claimed invention, the first opening comprises a plurality of through holes.

It is a further object of the claimed invention to provide a significantly improved bicycle having internally routed brake and shift cables. In accordance with an exemplary embodiment of the claimed invention, a bicycle having internally routed brake and shift cables is provided. The bicycle comprises a handlebar, a stem, a front fork, a frame, a brake cable assembly, a shift cable and a headset. The handlebar includes two brake levers and a shift lever attached to respective two ends of the handlebar. The stem includes a first end with a transverse opening for supporting and securing the handlebar and a second end with a longitudinal opening opposite the first end. The front fork includes a pair of hollow tubular fork legs and a hollow steerer tube connected to the pair of hollow tubular fork legs, and the hollow steerer tube has a first opening formed thereon. The frame includes a top tube, a down tube and a hollow head tube with a second opening formed thereon, and the second opening communicates the first opening of the hollow steerer tube. The brake cable assembly includes a front brake cable and a rear brake cable for linking the brake levers attached on the two ends of the handlebar to a front brake and a rear brake, respectively. The shift cable is used for linking the shift lever attached on the handlebar to a derailleur. Wherein the stem secures the handlebar to the front fork via the headset such that movement of the handlebar results in movement of the stem and the front fork, the front brake cable coupled to the brake lever is routed internally within the handlebar, the stem and the hollow steerer tube of the front fork and then linked to the front brake, the rear brake cable coupled to the brake lever is routed internally within the handlebar, the stem, the hollow steerer tube, the first opening, the second opening and the frame and then linked to the rear brake, and the shift cable coupled to the shift lever is routed internally within the handlebar, the stem, the hollow steerer tube, the first opening, the second opening and the frame and then linked to the derailleur.

In accordance with an exemplary embodiment of the claimed invention, the shape of the first opening of the hollow steerer tube is selected from one of an oval, an oblong and a circle.

In accordance with an exemplary embodiment of the claimed invention, the second opening of the hollow head tube communicates with the down tube of the frame.

In accordance with an exemplary embodiment of the claimed invention, the hollow head tube further comprises a third opening communicating with the top tube of the frame, the first opening of the hollow steerer tube respectively communicates with the second opening and the third opening.

In accordance with an exemplary embodiment of the claimed invention, the first opening comprises a plurality of through holes.

In accordance with an exemplary embodiment of the claimed invention, the bicycle further comprises a clamp disposed between the headset and the stem, the headset has an external threaded lateral, and the clamp has an internal threaded wall corresponding to the external threaded lateral of the headset.

In accordance with an exemplary embodiment of the claimed invention, the rear brake cable coupled to the brake lever is routed internally within the handlebar, the stem, the hollow steerer tube, the first opening, the second opening and the down tube and then linked to the rear brake, and the shift cable coupled to the shift lever is routed internally within the handlebar, the stem, the hollow steerer tube, the first opening, the second opening and the down tube and then linked to the derailleur.

In accordance with an exemplary embodiment of the claimed invention, the rear brake cable coupled to the brake lever is routed internally within the handlebar, the stem, the hollow steerer tube, the first opening, the third opening and the top tube and then linked to the rear brake, and the shift cable coupled to the shift lever is routed internally within the handlebar, the stem, the hollow steerer tube, the first opening, the second opening and the down tube and then linked to the derailleur.

In comparison with the prior art, the brake cables and the shift cables of the present invention are routed internally within the bicycle tube, any brake or shift cables cannot be seen from outward appearance of the entire bicycle. It can not only protect the cable assembly from damage and dust, but also enhance the aerodynamic efficiency of the bicycle, and thus achieving the safety of cycling.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 is a schematic view of a conventional bicycle;

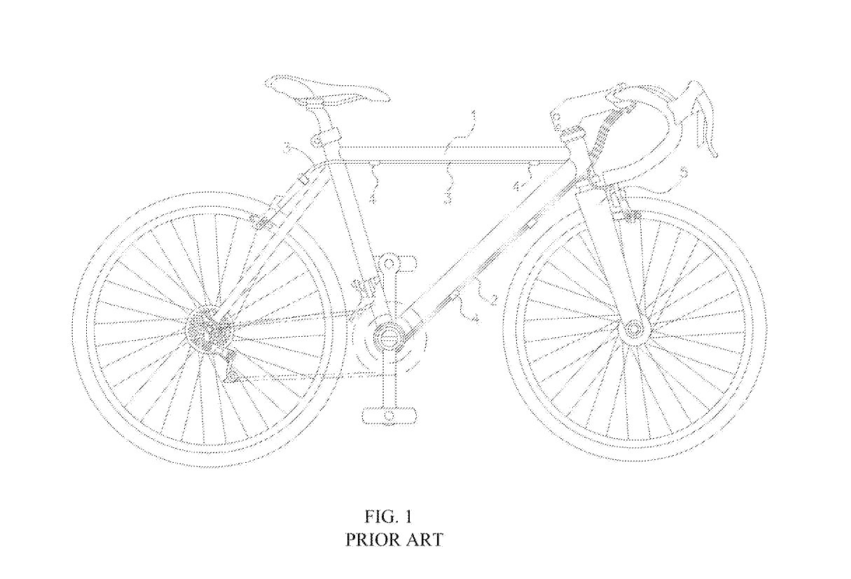

FIG. 2 is an exploded perspective view of a portion of the bicycle in accordance with an exemplary embodiment of the claimed invention;

FIG. 3 is a perspective view of a front fork in accordance with an exemplary embodiment of the claimed invention;

FIG. 4 is a perspective view of a front fork in accordance with another exemplary embodiment of the claimed invention;

FIGS. 5A to 5C are schematic views showing various modifications of the head tube of the bicycle in accordance with exemplary embodiments of the claimed invention;

FIG. 6 is an exploded perspective view of a portion of the bicycle illustrating the cable routing system of FIG. 2;

FIG. 7 is a partial section view of a portion of the bicycle illustrating a cable routing system of FIG. 6;

FIG. 8 is a schematic view of a bicycle illustrating the cable routing system in accordance with an exemplary embodiment of the claimed invention; and

FIG. 9 is a schematic view of a bicycle illustrating the cable routing system in accordance with another exemplary embodiment of the claimed invention.

### DETAILED DESCRIPTION OF THE EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

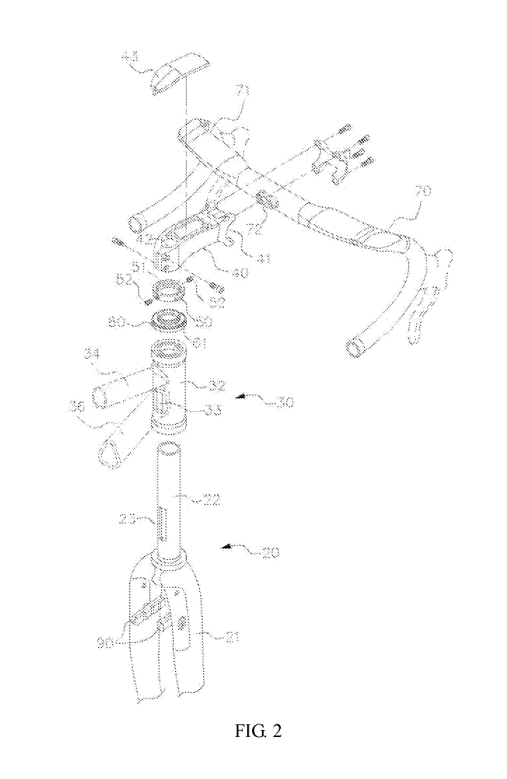

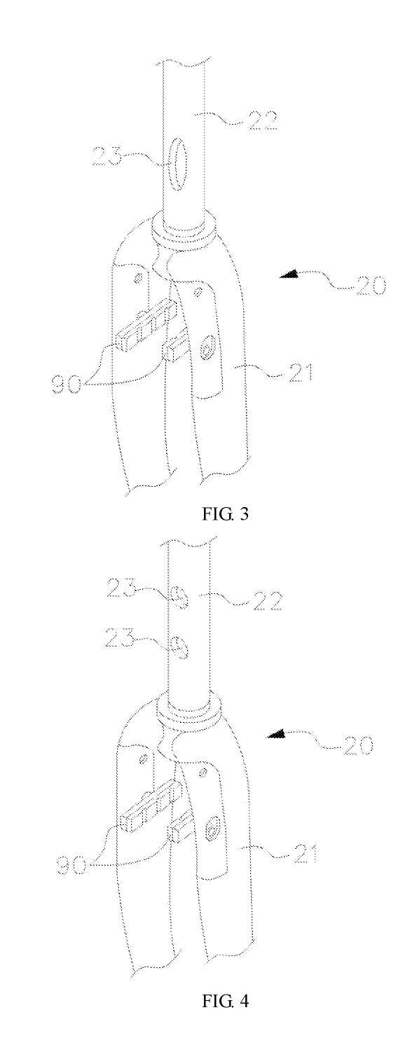

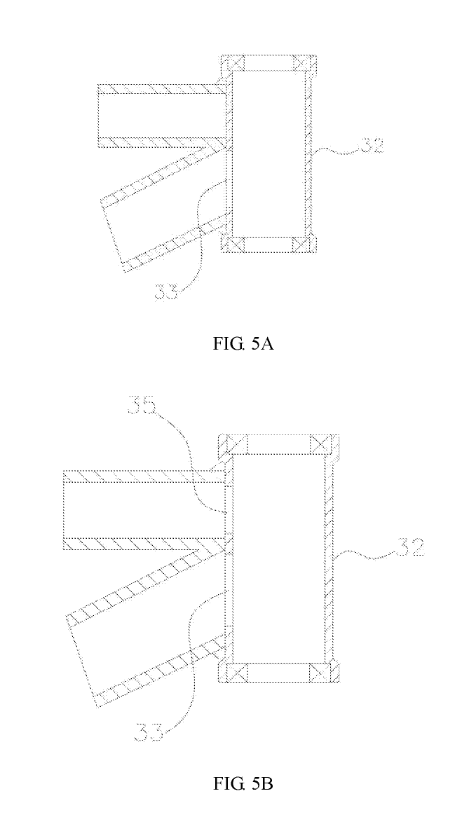

Referring to FIGS. 2 to 4. FIG. 2 is an exploded perspective view of a portion of the bicycle in accordance with an exemplary embodiment of the present invention. FIG. 3 is a perspective view of a front fork in accordance with an exemplary embodiment of the present invention. FIG. 4 is a perspective view of a front fork in accordance with another exemplary embodiment of the present invention. The bicycle of the present invention comprises a handlebar 70, a stem 40, a clamp 50, a headset 60, a frame 30 and a front fork 20.

Typically, the handlebar 70 has two brake levers and a shift lever attached to respectively two ends of the handlebar 70. The frame 30 includes a top tube 34, a down tube 36 and a hollow head tube 32. The stem 40 has a first end with a transverse opening 41 for supporting and securing the handlebar 70 and a second end with a longitudinal opening 42 opposite the first end. When the handlebar 70 is assembled with the stem 40 via the transverse opening 41, the front fork 20 is assembled with the stem 40 via the longitudinal opening 42 through the hollow head tube 32. Then, the headset 60 and the clamp 50 disposed between the headset 60 and the stem 40 are used to secure the front fork 20 to the longitudinal opening 42 of the stem 40 through the hollow head tube 32 of the frame 30 such that movement of the handlebar 70 results in movement of the stem 40 and the front fork 20. It needs to be noted that the clamp 50 is disposed between the headset 60 and the stem 40, the headset 60 has an external threaded lateral 61, and the clamp 50 has an internal threaded wall 51 corresponding to the external threaded lateral 61 of the headset 60.

The front fork 20 of the present invention comprises a pair of hollow tubular fork legs 21 and a hollow steerer tube 22 connected to the pair of hollow tubular fork legs 21. The hollow steerer tube 22 has a first opening 23 formed thereon, and the hollow head tube 32 has a second opening 33 formed thereon and corresponding and communicating to the first opening 23 of the hollow steerer tube 22 when the hollow steerer tube 22 of the front fork 20 is secured to the stem 40 through the hollow head tube 32.

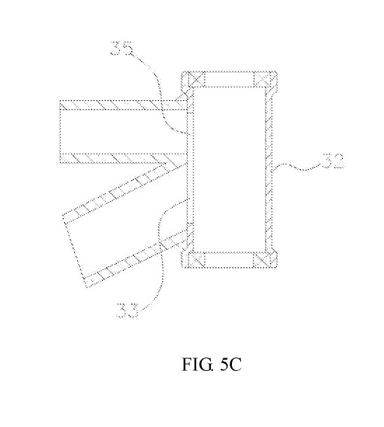

Referring to FIGS. 5A to 5C. FIGS. 5A to 5C are schematic views showing various modifications of the head tube of the bicycle in accordance with exemplary embodiments of the present invention. In general, the positions of the rear brake and the derailleurs are respectively located at the frame 30 nearby the down tube 36 such that the second opening 33 of the hollow head tube 32 communicates with the down tube 36 of the frame 30, as shown in FIG. 5A. Alternatively, in some embodiments, the positions of the rear brake and the derailleurs are respectively located at the frame 30 nearby the top tube 34 and the down tube 36 such that the hollow head tube 32 further has a third opening 35 for communicating with the top tube 34 of the frame 30. When the hollow steerer tube 22 of the front fork 20 is secured to the stem 40 through the hollow head tube 32, the first opening 23 of the hollow steerer tube 22 respectively communicates with the second opening 33 and the third opening 35, as shown in FIGS. 5B and 5C.

Referring to FIGS. 3 and 4 again, the first opening 23 of the hollow steerer tube 22 may be designed as a single through hole or a plurality of through holes, which may be oval, oblong or circular, as long as it is capable of communicating with the top tube 34 and the down tube 36 of the frame 30, various changes may be made without departing from the spirit and scope of the invention.

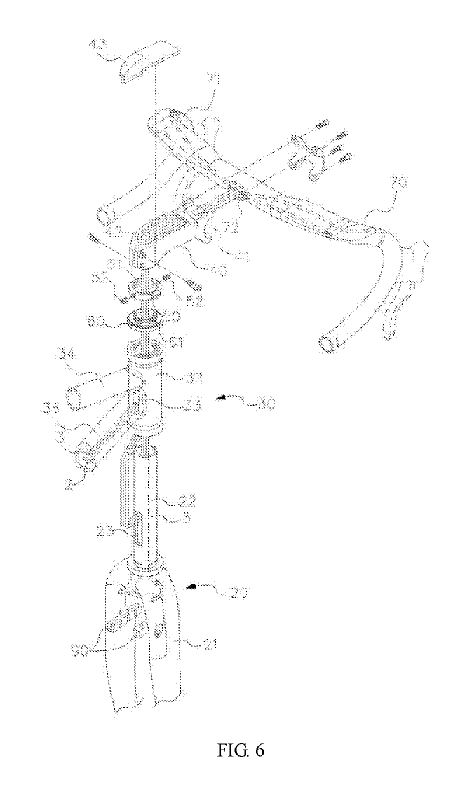

Referring to FIGS. 6 to 9, the handlebar 70 of the present invention has two brake levers and a shift lever attached to respectively two ends of the handlebar 70. A brake cable assembly includes a front brake cable 3 and a rear brake cable 3 for linking the brake levers attached on the two ends of the handlebar 70 to a front brake 90 and a rear brake 92, respectively. Furthermore, a shift cable 2 is used for linking the shift lever attached on the handlebar 70 to a derailleur 80.

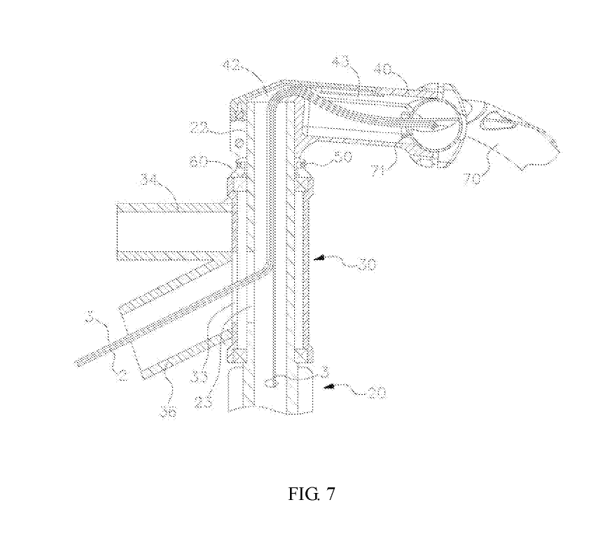

When assembling the front brake cable 3, the rear brake cable 3 and the shift cable 2, the front brake cable 3 coupled to the brake lever is routed internally within the handlebar 70 via the through holes 71, a cable outlet 72 of the handlebar 70, the stem 40 and the hollow steerer tube 22 of the front fork 20 and then linked to the front brake 90, and the rear brake cable 3 coupled to the brake lever is routed internally within the handlebar 70 via the through holes 71, the cable outlet 72 of the handlebar 70, the stem 40, the hollow steerer tube 22, the first opening 23, the second opening 33 and the down tube 36 of the frame 30 and then linked to the rear brake 92. Further, the shift cable 2 coupled to the shift lever is routed internally within the handlebar via the through holes 71, the cable outlet 72 of the handlebar 70, the stem 40, the hollow steerer tube 22, the first opening 23, the second opening 33 and the down tube 36 of the frame 30 and then linked to the derailleur 80. Next, the hollow steerer tube 22 of the front fork 20 is then passed through the hollow head tube 32 into the longitudinal opening 42 of the stem 40 and a domed element 43 is used to cover the longitudinal opening 42 of the stem 40. Further, two screws on both sides of the longitudinal opening 42 of the stem 40 are locked so that the front fork 20 is firmly assembled with the stem 40. At this time, the first opening 23 corresponds to and communicates with the second opening 33, as shown in FIG. 7. Finally, the headset 60 is rotated in the direction of the longitudinal opening 42 of the stem 40. Since the stem 40 has been firmly assembled with the front fork 20, the rotation of the headset 60 will advance the clamp 50 and generate a pressing force against the headset 60. Two bolts 52 on both sides of the clamp 50 are then locked to complete the operation of the front fork 20 being locked to the bicycle.

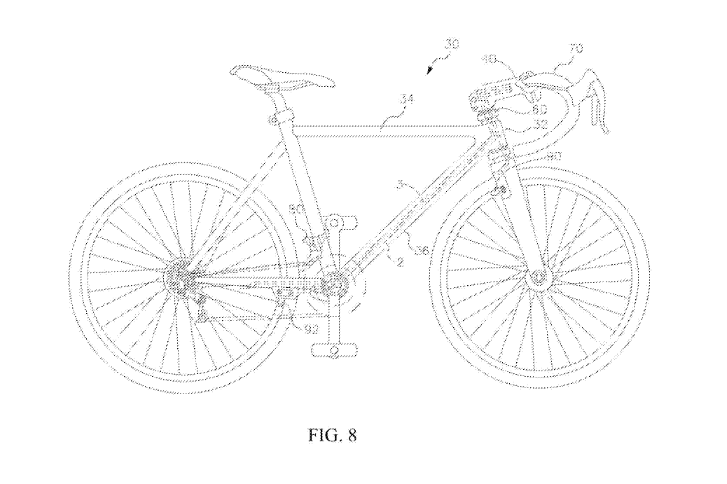

It needs to be noted that the present embodiment is described as an example in which the rear brake 92 is attached to the distal end of the down tube 36, and the rear brake cable 3 and the shift cable 2 are routed internally within the handlebar 70, the stem 40, the hollow steerer tube 22, the first opening 23, the second opening 33 and the down tube 36, and then linked to the rear brake 92 and the derailleur 80, as shown in FIG. 8.

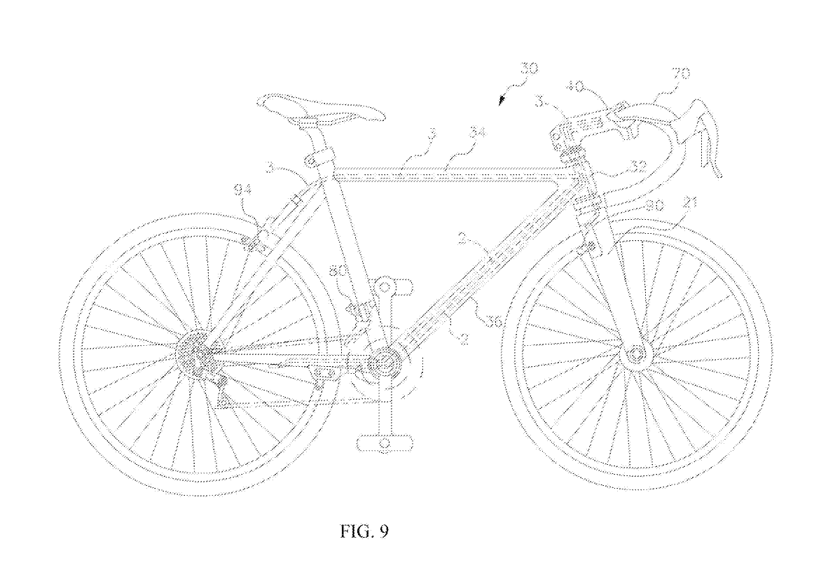

If the conventional bicycle is provided as an example in which the rear brake 94 is attached to the distal end of the top tube 34, and the rear brake cable 3 coupled to the brake lever is routed internally within the handlebar 70, the stem 40, the hollow steerer tube 22, the first opening 23, the third opening 35 and the top tube 34, and then linked to the rear brake 94. The shift cable 2 coupled to the shift lever is routed internally within the handlebar 70, the stem 40, the hollow steerer tube 22, the first opening 23, the second opening 33 and the down tube 36, and then linked to the derailleur 80, as shown in FIG. 9.

In comparison with the prior art, the brake cables and the shift cables of the present invention are routed internally within the bicycle tube, any brake or shift cables cannot be seen from outward appearance of the entire bicycle. It can not only protect the cable assembly from damage and dust, but also enhance the aerodynamic efficiency of the bicycle, and thus achieving the safety of cycling.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A front fork for a bicycle including a handlebar, a stem, a headset, a frame and the front fork, the frame having a top tube, a down tube and a hollow head tube, the stem securing the handlebar to the front fork via the headset such that movement of the handlebar results in movement of the stem and the front fork, the front fork comprising:
a pair of hollow tubular fork legs; and
a hollow steerer tube, connected to the pair of hollow tubular fork legs and having a first opening formed thereon;
wherein the hollow head tube has a second opening formed thereon and corresponding and communicating to the first opening of the hollow steerer tube when the hollow steerer tube of the front fork is secured to the stem through the hollow head tube.

2. The front fork of claim 1, wherein the shape of the first opening of the hollow steerer tube is selected from one of an oval, an oblong and a circle.

3. The front fork of claim 1, wherein the second opening of the hollow head tube communicates with the down tube of the frame.

4. The front fork of claim 3, wherein the hollow head tube further comprises a third opening communicating with the top tube of the frame, the first opening of the hollow steerer tube respectively communicates with the second opening and the third opening.

5. The front fork of claim 3, wherein the first opening comprises a plurality of through holes.

6. The front fork of claim 4, wherein the first opening comprises a plurality of through holes.

7. A bicycle comprising:
a handlebar, having two brake levers and a shift lever attached to respective two ends of the handlebar;
a stem, having a first end with a transverse opening for supporting and securing the handlebar and a second end with a longitudinal opening opposite the first end;
a front fork, including a pair of hollow tubular fork legs and a hollow steerer tube connected to the pair of hollow tubular fork legs, the hollow steerer tube having a first opening formed thereon;
a frame, including a top tube, a down tube and a hollow head tube with a second opening formed thereon, the second opening communicating the first opening of the hollow steerer tube;
a brake cable assembly, including a front brake cable and a rear brake cable for linking the brake levers attached on the two ends of the handlebar to a front brake and a rear brake, respectively;
a shift cable, used for linking the shift lever attached on the handlebar to a derailleur; and
a headset ;
wherein the stem secures the handlebar to the front fork via the headset such that movement of the handlebar results in movement of the stem and the front fork, the front brake cable coupled to the brake lever is routed internally within the handlebar, the stem and the hollow steerer tube of the front fork and then linked to the front brake, the rear brake cable coupled to the brake lever is routed internally within the handlebar, the stem, the hollow steerer tube, the first opening, the second opening and the frame and then linked to the rear brake, and the shift cable coupled to the shift lever is routed internally within the handlebar, the stem, the hollow steerer tube, the first opening, the second opening and the frame and then linked to the derailleur.

8. The bicycle of claim 7, wherein the shape of the first opening of the hollow steerer tube is selected from one of an oval, an oblong and a circle.

9. The bicycle of claim 7, wherein the second opening of the hollow head tube communicates with the down tube of the frame.

10. The bicycle of claim 9, wherein the hollow head tube further comprises a third opening communicating with the top tube of the frame, the first opening of the hollow steerer tube respectively communicates with the second opening and the third opening.

11. The bicycle of claim 9, wherein the first opening comprises a plurality of through holes.

12. The bicycle of claim 10, wherein the first opening comprises a plurality of through holes.

13. The bicycle of claim 7, further comprises a domed element covering the longitudinal opening of the stem.

14. The bicycle of claim 7, further comprises a clamp disposed between the headset and the stem, the headset has an external threaded lateral, and the clamp has an internal threaded wall corresponding to the external threaded lateral of the headset.

15. The bicycle of claim 9, wherein the rear brake cable coupled to the brake lever is routed internally within the handlebar, the stem, the hollow steerer tube, the first opening, the second opening and the down tube and then linked to the rear brake, and the shift cable coupled to the shift lever is routed internally within the handlebar, the stem, the hollow steerer tube, the first opening, the second opening and the down tube and then linked to the derailleur.

16. The bicycle of claim 10, wherein the rear brake cable coupled to the brake lever is routed internally within the handlebar, the stem, the hollow steerer tube, the first opening, the third opening and the top tube and then linked to the rear brake, and the shift cable coupled to the shift lever is routed internally within the handlebar, the stem, the hollow steerer tube, the first opening, the second opening and the down tube and then linked to the derailleur.
